(19) United States
(12) Patent Application Publication
(10) Pub. No.: US 2018/0322435 A1
(43) Pub. Date: Nov. 8, 2018

(54) PERFORMANCE & PREDICTIVE DIMENSIONS FOR BUSINESS INTELLIGENCE DATA

(71) Applicant: Aurora Predictions, LLC, Irvine, CA (US)

(72) Inventor: Robert J. Zwerling, Newport Beach, CA (US)

(21) Appl. No.: 15/968,140

(22) Filed: May 1, 2018

Related U.S. Application Data
(60) Provisional application No. 62/500,763, filed on May 3, 2017.

(51) Int. Cl. G06Q 10/06; G06N 5/02

(52) U.S. Cl. CPC G06Q 10/06393; G06N 5/02

(57) ABSTRACT

Disclosed is a non-RDB geo-spatial database with a display interface enabling the computation of performance and predictive mathematical dimensions without requiring a dramatic increase in computational resources for every fourth dimension. Accordingly, dimensions can be added at any time and combined in an intelligent hierarchy to filter, segment, and predict data. The creation of performance dimensions and a hierarchical drill path can be developed without the aid of IT programming.

### CROSS REFERENCE

This application claims priority to U.S. Patent Application No. 62/500,763 filed May 3, 2017, the specification(s) of which is/are incorporated herein in their entirety by reference.

### FIELD OF THE INVENTION

The present invention relates to business intelligence processing methods, more specifically, to business intelligence tools for assessing business data.

### BACKGROUND OF THE INVENTION

Enterprise Business Intelligence (“BI”) tools emerged over thirty years ago to enable multi-dimensional reporting on data. Dimensions are used to segment data into groups (e.g. by region, state, city, etc.). BI for online analytical processing (“OLAP”) comes in largely three varieties: Multi-Dimensional OLAP (“MOLAP”), Relational OLAP (ROLAP) and Hybrid OLAP (“HOLAP”). All are multi-dimensional in nature and based on a relational database (“RDB”) design schema generally referred to as the “Cube” (though there are specialized expressions such as Oracle Hyperion Essbase).

The RDB enabled reporting on databases with relatively simple syntax as compared to binary or higher-level language coding. The RDB could make links and joins between data tables to create intermediate tables from which a data report could be created. While flexible, these links and joins required significant computing resources and time when the database was large and the report complex. To overcome this issue, the Cube design was created. The concept of the Cube was to eliminate ad-hoc links and joins by sequentially aligning data tables with specific data. If the programmer knew in advance what questions had to be answered with respect to data, time, and dimension, a geo-spatial database (i.e., the Cube) could be programmed so that reports could be generated by drilling through the Cube rather than making links and joins through dispersed tables to an intermediate table. Thus, the Cube would be exceptionally faster. However, once a Cube was built, modifying the Cube to add more dimensions was impractical and, as such, another Cube typically was built. This condition is referred to as Cube rigidity.

Another problem with the Cube involved mathematical calculations. RDBs employ relational algebra for computations, which has proven to be slow as a result of the way calculations are performed and because it typically involves interpretive code (i.e. code that is read then interpreted into language the computer can execute). Accordingly, the design response to mitigate relational algebra was to pre-calculate and store results for every dimensional combination in the Cube and, specifically, through a hierarchy of dimensions. In this way the result was stored in lieu of real-time calculations. However, the storage of pre-calculated results creates a near 2× compound growth in the size of data stored in the Cube. Thus, more calculations, more complex calculations and more dimensions create more pre-calculated data to be stored. As data grows, retrieval time also increases. As such, the growth of the data at some point overtakes the originally intended performance improvement. Further, consumption of computing resources becomes a problem. Since it takes about 10× more computing resources for every fourth dimension, Cubes typically and practically do not operate above approximately a dozen dimensions. Limiting the calculations and dimensions thus limits the intelligence that can be extracted from the data in the Cube's database.

The fundamental problem with Cubes is an inherent limitation in the underlying RDB for OLAP, namely, the RDB is good for storing large volumes of small transactions requiring relatively simple mathematical complexity. This capability is a limitation for OLAP but bodes well for online transactional processing (OLTP) that many enterprise business applications are built on (e.g. ERP, CPM, POS, etc). However, OLAP requires the retrieval of a small volume of large transactions performing a higher level of mathematical complexity.

The Cube helped mitigate the links and joins of data retrieval, but did not aide in increasing the ability to perform higher levels of mathematical complexity, which in turn limits the dimensionally of Cubes. As such, a practical incorporation of mathematical dimensions based on the performance of data over time as well as user defined rules (which also may be mathematical) compounds the limitations of the Cube (dimensionally, mathematically, and in regards to computational resources).

The concept of the present invention employs a non-RDB geo-spatial database (“matrix”) with a display interface (“wizard”) enabling the computation of performance and predictive mathematical dimensions without requiring a dramatic increase in computational resources and without restriction on the number of dimensions. Accordingly, dimensions can be added at any time and combined in an intelligent hierarchy to filter, segment, and predict data thus relieving the limitation of Cube rigidity, compound growth, dimensions, and mathematics to be performed.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### SUMMARY

The current enterprise tools and methodologies for BI dimensionality that use Cubes for OLAP have inherent limitations in the practical deployment of a large number of dimensions, as well as, dimensions based on the mathematical performance of the data over large amounts of data. While performance dimensions can be programmed in Cubes (e.g. a dimension of salesman one standard deviation beyond the mean of the collection of salesmen), its practical use for online analysis may result in wait times measured in hours. So, while the Cube may be built with a performance dimension, its use would be impractical for on-line analytics. As such, BI tools using Cubes have the limited practical capability of simply presenting data to answer pre-selected questions that have been programmed in the Cube. Questions that involve quantities of mathematics and dimensions are not practically accommodated and questions outside the scope that have not been programmed typically require another Cube (a process that can take months to develop). The practical application of BI Cubes then is reporting of historical data via a limited set of dimensions that responds to a limited set of pre-programmed questions. This limitation means that the power of human's who think to ask questions when confronted with data is stifled because a question not programmed cannot be answered or even explored. And it is new questions that lead to new answers and innovations. To attack the problem, BI tool vendors typically employ more hardware and in-memory processing to gain marginal improvement in performance and capability. However, these methods do not address the underlying structural constrictions and the employment of more hardware drives the cost of BI higher and requires more staff to manage.

The present invention features a non-relational database not employing relational algebra. The configuration does not limit the number of dimensions and enables users to develop and arrange dimensions in any hierarchy without programming (through the use of wizards). The invention enables the on-the-fly creation of physical and performance dimensions and the assembly of dimensions into any number of hierarchies, ail without programming. The un-bounded dimensionality and the organization of dimensions enables a user to explore data from any number of perspectives and continuously ask new questions in the process of discovery. The user can also use advanced statistics to calculate performance dimensions that can be assembled into hierarchies that yield predictions of the future of the data being analyzed.

### BRIEF DESCRIPTION OF THE DRAWINGS

The features and advantages of the present invention will become apparent from a consideration of the following detailed description presented in connection with the accompanying drawings in which:

FIGS. 1A-1D show an exemplary flow chart of an embodiment of the present invention.

FIG. 2 shows an embodiment of the system of the present invention.

### DEFINITIONS

As used herein, the term “business intelligence” or “BI” refers to a technology-driven process for analyzing, reporting, and visualizing data to provide information that aides users in making informed business decisions.

As used herein, the term “geo-spatial database” refers to a matrix of data records storing business data. Each data record in the present invention's geo-spatial database has an identical configuration of rows and columns. The data in the record may comprise data about and acquired from a plurality of sources internal and external to the business. Non-limiting examples of business data include store names, locations, dollar sales, units sold, etc.

As used herein, the term “dimension” is defined as a category characterizing a grouping of business data in the geo-spatial database. To illustrate, a dimension may be a collection of stores, a collection of cities (with each city associated with a collection of one or more stores), a state (comprising one or more cities), a region (comprising one or more states), etc.

As used herein, the term “data attribute” is defined as a time series of specific data in the geo-spatial database. For example, dollars of sales or units sold are data attributes stored by month for the past 24 months in the geo-spatial database for the store dimension for each store.

As used herein, the term “business rule” is defined as a criterion by which to filter business data stored in the geo-spatial database.

As used herein, the term “performance dimension” or “PD” refers to a dimension characterizing a data attribute in the geo-spatial database based on the performance of said data with respect to time, dimension and a business rule. Performance of the data is determined by one or more business rules for a given time period. For example, a business rule may be applied to stores in the Western region where the business rule is the performance of each store having sales within the last twelve months that are one, two or three standard deviations from the mean value of sales across all stores within the Western region.

As used herein, the term “hierarchy” refers to a designated ordering of selected dimensions. To illustrate, for three selected dimensions: (1) a sales within a country, (2) sales within a region, and (3) sales within a state; a hierarchy may be the sales within a country, then sales within each region in the country, then sales within each state within each region of the country.

As used herein, the term “drill path” refers to an organization of dimensions into a hierarchy. A user may use this hierarchy to access an organized set of desired data from the geo-spatial database. A drill path can be illustrated via an organizational chart where a user may select a data attribute (e.g. sales) in the geo-spatial database and “drill” to see the sales in a drill path organized by dimension from top to bottom (e.g. sales within a country, then sales within regions in each country, then sales within each state within each region within each country).

As used herein, the term “time comparison” refers to the time of interest within which to assess the performance of a data attribute (e.g. sales at a store on a YTD basis compared to sales at the same store last year over the same YTD time basis).

As used herein, the term “statistics” refers to one of the major categories of business rules and is defined as that which is not arithmetical; e.g. statistics concerning such calculations as standard deviation, statistical process control index, etc.

As used herein, the term “rolling period” is defined as a set period of time that moves in relation to the current time; e.g. the last six months from the current month.

### DETAILED DESCRIPTION OF THE INVENTION

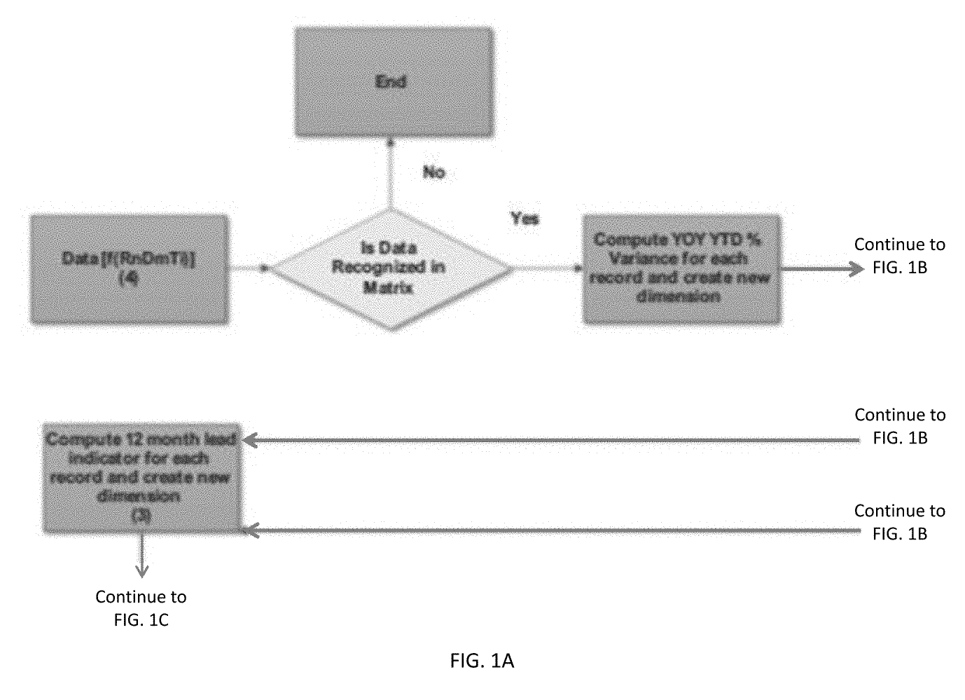

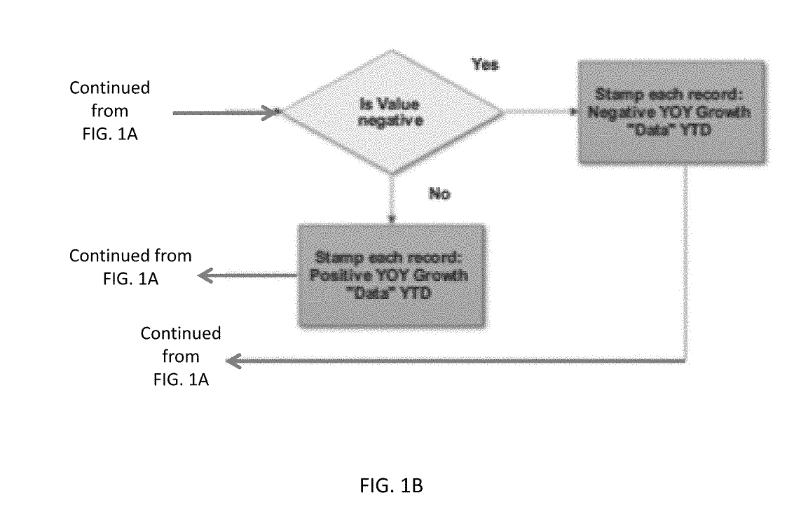

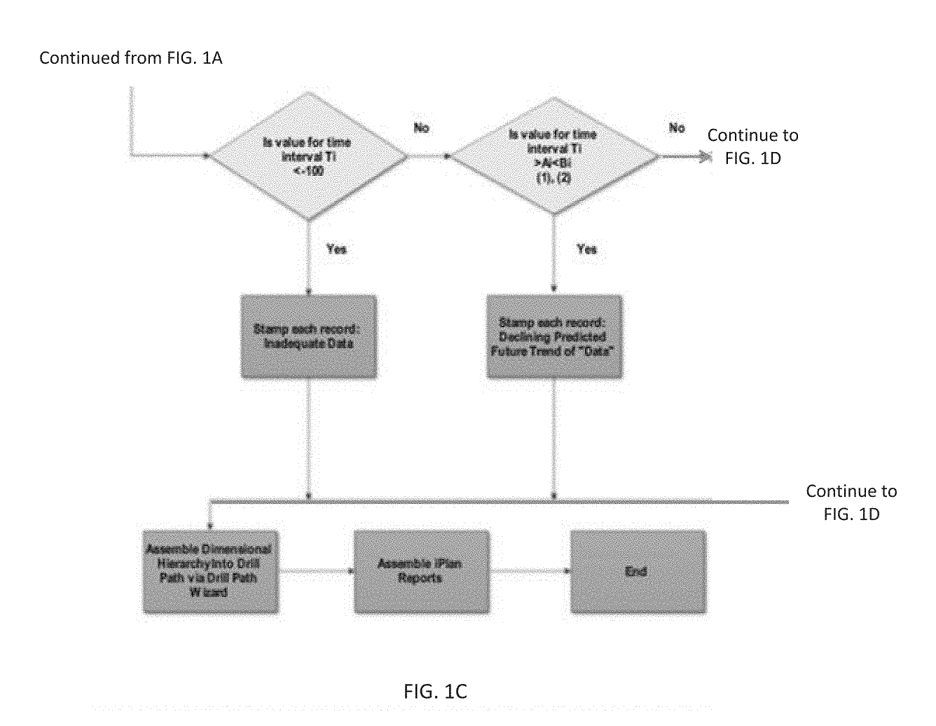

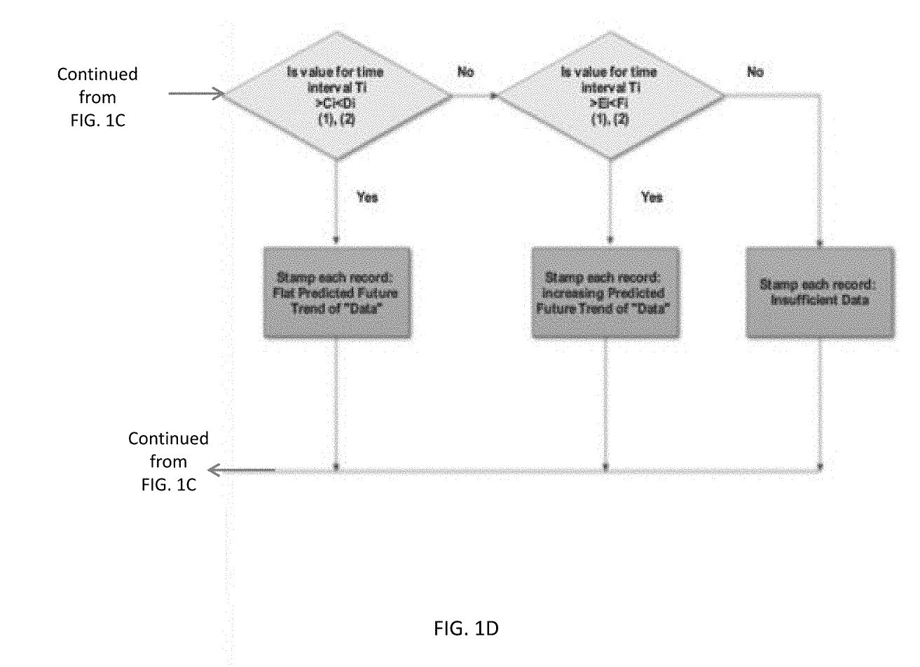

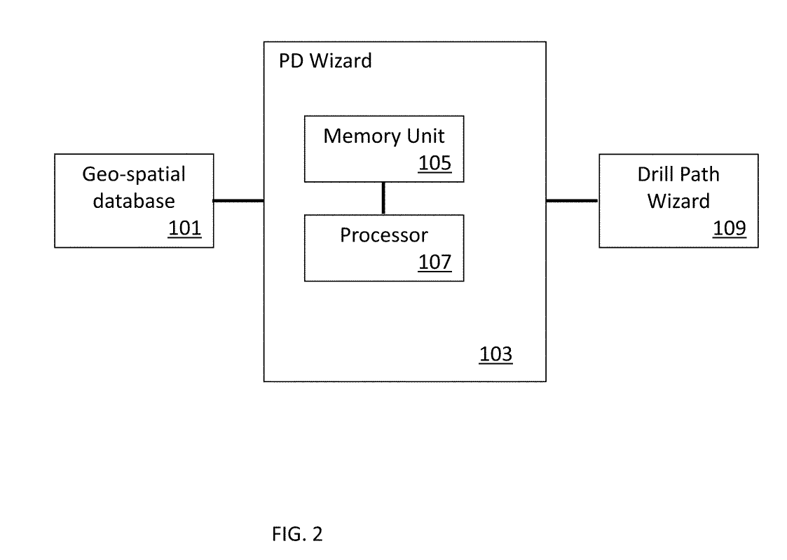

Referring now to FIGS. 1A-2, the present invention features a business performance measurement and prediction system providing a user an ability to produce a business intelligence (BI) performance dimension (PD) using a geo-spatial database (101). A dimension is herein defined as a structure to categorize data in the geo-spatial database (101). A PD may then be defined as a dimension characterizing data based on a performance of said data, according to one or more business rules, over a time period. The system of the present invention may provide the user an ability to readily access the PD, or a nonperformance dimension (NPD), via a drill path.

The geo-spatial database (101) may comprise a plurality of data records storing business data. Each data record may be categorized by a unique combination of one or more dimensions and one or more data attributes. In other embodiments, a display interface (“PD wizard”) may be operatively coupled to the geo-spatial database (101). A non-limiting implementation of the PD wizard (103) may be a graphical user interface. The PD wizard (103) may enable a user to specify a set of criteria on which to base a new PD. In additional embodiments, this set of criteria may comprise a user-selected dimension, a user-selected data attribute, a user-selected time period, and one or more user-selected business rules.

In further embodiments, the PD wizard (103) may comprise a processor (107) operatively coupled to a memory unit (105). In some embodiments, the memory unit (105) may store a main algorithm and a set of performance algorithms for executing a set of pre-defined business rules. In supplementary embodiments, the memory unit (105) may also store a set of dimensions, a set of data attributes, and a set of time periods from which a user may select. The processor (107) may execute the main algorithm, which during execution, calls one or more performance algorithms according to the one or more business rules selected by the user (from the set of pre-defined business rules).

In some embodiments, the main algorithm may acquire a unique data set from one or more identified data records, of the plurality of data records. Data in the unique data set has the selected dimension, the selected data attribute, and the selected time period. Next, the user may identify the one or more business rules selected. The algorithm then calls the one or more performance algorithms (corresponding to the one or more selected business rules), which calculates a performance of the unique data set thus producing the new PD. A label characterizing the new PD is applied as its name. The PD wizard (103) may add the new PD to each of the one or more identified data records and label the new PD with a characterizing name. In alternate embodiments, the user may provide the name of the new PD. The updated data records may then be stored in the geo-spatial database (101).

Performance results may be exposed to the user via a new drill path created for the new PD, where a plurality of drill paths exists in the geo-spatial database (101) for a plurality of PDs and NPDs. The new drill path may generate a hierarchical order for one or more selected dimensions by listing (without programming) the hierarchical order for each dimension in the drill path and that all data attributes in the geo-spatial database are available to be segmented in the hierarchical order specified by the drill path. In additional embodiments, the PD wizard (109) may produce a prediction of a trend for a data attribute and create a new PD.

Consistent with previous embodiments, the one or more pre-defined business rules may be grouped by time comparisons, statistics, or rolling periods. The set of pre-defined business rules grouped by time comparison may be configured to compare a performance of the unique data set during a user defined point in time or over a user defined period of time. The set of pre-defined business rules grouped by statistics may be configured to calculate a performance of the unique data set according to statistical requirements (e.g. statistical deviation of a set of data from a determined standard). The set of pre-defined business rules grouped by rolling periods may be configured to calculate a performance of the unique data set over a user defined rolling period of time.

The set of pre-defined business rules may be further categorized, for user selection, by methods of count, percent or standard deviation. Boolean logic may be employed to allow the user to define one or more cut-offs for each method. The label of the new PD may also comprise the one or more cut-offs.

A non-limiting application of the system of the present invention would be to create a PD that would identify those retail stores of a retail company that had sales for the current month that were one or more standard deviations above or below the mean value (“Key Performance Indicator” or “KPI”) of the sales across all the stores, to which the PD would then be inserted at the top level of a drill path to segment those stores that have sales this current month greater than +1 standard deviations above the KPI, stores with sales for this current month within +1 to −1 standard deviations of the KPI, and stores with sales for this current month below −1 standard deviations of the KPI, and following this segmentation in the drill path, would be the dimension of stores to identify which stores were contained in each of the previous segmentations.

A non-limiting application of the system of the present invention would be that referring now to FIGS. 1A-1D. Start by selecting a particular data attribute for dimensional segmentation with regard to its year-over-year (YOY) performance on a year-to-date (YTD) basis (e.g. the performance of the data attribute, sales, as to its growth or decline of sales in the dimension of retail stores in the first six months of this year as compared to the first six months of the previous year). Every record in the matrix contains the data attribute values for sales for each retail store this year and last year. Each record is then tested for either increasing or decreasing sales. The records are stamped increasing or decreasing by creating a reference table that associates each record and the result of the test. From there another separate test is done on the sales of each retail store using the 12 Month Lead Indicator determine whether the future of the trend will be positive (increasing trend of sales), negative (decreasing trend of sales), neutral (flat trend of sales), or if there is insufficient data to make a definitive determination. As before, each record is stamped accordingly and the results are stored in a reference table that associates each record and the result of the test. There are now two new performance dimensions (PDs) for YOY Growth of the sales data attribute YTD and Leading Indicator for the future trend of sales that are now available to be assembled in a “Drill Path”. The Drill Path forms a hierarchy of dimensions. Therefore, the YOY Growth of the sales data attribute YTD can be listed as the top dimension, then the Leading Indicator below, and the bottom dimension is the store dimension. Thus a user can engage a report that compares YOY store sales data attribute on an YTD basis and the Drill Path will segment those particular stores that have good sales growth YTD, then a positive Leading Indicator (i.e. stores with good historical sales trends predicted to get better in the future). It follows that the other segmentations following the Drill Path can show: stores with good growth in the sales data attribute YTD but are predicted to have declining future growth in sales, stores with negative sales growth but predicted to improve, and stores with negative sales growth that are predicted to decline further in the future.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. Reference numbers recited in the claims are exemplary and for ease of review by the patent office only, and are not limiting in any way. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting of”, and as such the written description requirement for claiming one or more embodiments of the present invention using the phrase “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A business performance measurement and prediction system providing a user an ability to produce a business intelligence (BI) performance dimension (PD) in a geo-spatial database, wherein a dimension is defined as a structure to categorize data in the geo-spatial database, wherein a PD is a dimension characterizing data based on a performance of said data, according to one or more business rules, over a time period, wherein the system provides the user an ability to readily access the PD or a nonperformance dimension (NPD) via a drill path, the system comprising:
(a) the geo-spatial database (101) comprising a plurality of data records storing business data, wherein each data record is categorized by a unique combination of one or more dimensions, wherein each data record contains one or more data attributes, wherein a data attribute is a the business related data assembled in an interval of time over a period of time, wherein data characterized by each data attribute has a numeric value;
(b) a display interface (“PD wizard”) (103), operatively coupled to the geo-spatial database (101), receiving a set of criteria, on which to base a new PD, from a user, wherein the set of criteria comprises a selected dimension, a selected data attribute, a selected time period, and one or more selected business rules, wherein the PD wizard (103) comprises:
(i) a memory unit (105) storing a main algorithm, a set of performance algorithms for executing a set of pre-defined business rules, a set of dimensions from which the user may select, a set of data attributes from which a user may select, and a set of time periods from which a user may select; and
(ii) a processor (107), operatively coupled to the memory unit (105), executing the main algorithm, wherein during execution the main algorithm calls one or more performance algorithms according to the one or more business rules selected by the user from the set of pre-defined business rules, wherein the main algorithm:
(A) acquires a unique data set from the plurality of data records, having the selected dimension, the selected data attribute, and the selected time period;
(B) receives from the user the one or more business rules selected; and
(C) calls the one or more performance algorithms, which calculates a performance of the unique data set according to the one or more business rules selected;
wherein the new PD comprises the performance, wherein a label characterizing the new PD is applied as a name of the new PD, wherein the new PD is added to each of the data records and stored in the reference table attached to the geo-spatial database (101), wherein a drill path is formed for the new PD to expose performance results by creating a hierarchical order for one or more selected dimensions by listing, without programming, wherein a plurality of drill paths exist for the geo-spatial database (101) for a plurality of PDs and NPDs, wherein PDs of a predictive statistical nature can be included in a drill path; e.g. to identify good trends that are predicted to deteriorate.

2. The system of claim 1, wherein the set of criteria comprises a plurality of data attributes.

3. The system of claim 1, wherein the one or more pre-defined business rules are grouped by time comparisons, statistics, or rolling periods.

4. The system of claim 3, wherein the set of pre-defined business rules grouped by time comparison are configured to compare a performance of the unique data set during a first user defined time period to a performance during a second user defined time period.

5. The system of claim 3, wherein the set of pre-defined business rules grouped by rolling periods are configured to calculate a performance of the unique data set over a user defined rolling period.

6. The system of claim 3, wherein the set of pre-defined business rules are further categorized, for user selection, by methods of count, percent or standard deviation, wherein Boolean logic is employed to allow the user to define one or more cut-offs for each method.

7. The system of claim 6, wherein the label characterizing the new PD further comprises the one or more cut-offs.

8. The system of claim 1, wherein the user provides a name for the label characterizing the new PD.

9. A business performance measurement and prediction method providing a user an ability to produce a business intelligence (BI) performance dimension (PD) in a geo-spatial database, wherein a dimension is defined as a structure to categorize data in the geo-spatial database, wherein a PD is a dimension characterizing data based on a performance of said data, according to one or more business rules, over a time period, wherein the system provides the user an ability to readily access the PD or a nonperformance dimension (NPD) via a drill path, the method comprising:
(a) providing the geo-spatial database comprising a plurality of data records storing business data, wherein each data record is categorized by a unique combination of one or more dimensions, wherein each data record comprises one or more data attributes, wherein a data attribute is business related to an interval of time and a series of points in time, wherein data characterized by each data attribute has a numeric value;
(b) specifying a set of criteria on which to base a new PD via a display interface (“PD wizard”) operatively coupled to the geo-spatial database, wherein the set of criteria comprises a selected dimension, a selected data attribute, a selected time period, and one or more selected business rules,
(c) extracting a set of data adhering to the set of criteria, wherein the new PD comprises the set of data,
(d) storing the new PD to each of the data records, wherein the new PD is labeled according to the set of criteria used to extract the new PD; and
(e) exposing performance results by creating a new drill path for the new PD by creating a hierarchical order of the selected dimensions by listing (without programming), wherein a plurality of drill paths may exist in the geo-spatial database for a plurality of PDs and NPDs,
Wherein, for example, a prediction of a trend of the selected data attribute can be assembled in the drill path comprising the new PD.

10. The method of claim 9, wherein the set of criteria comprises a plurality of data attributes.

11. The method of claim 9, wherein the one or more pre-defined business rules are grouped by time comparisons, statistics, or rolling periods.

12. The method of claim 11, wherein the set of pre-defined business rules grouped by time comparison are configured to compare a performance of the unique data set during a first user defined time period to a performance during a second user defined time period.

13. The method of claim 11, wherein the set of pre-defined business rules grouped by rolling periods are configured to calculate a performance of the unique data set over a user defined rolling period.

14. The method of claim 11, wherein the set of pre-defined business rules are further categorized, for user selection, by methods of count, percent or standard deviation, wherein Boolean logic is employed to allow the user to define one or more cut-offs for each method.

15. The method of claim 14, wherein the label characterizing the new PD further comprises the one or more cut-offs.

16. The method of claim 9, wherein the user provides a name for the label characterizing the new PD.

17. A business performance measurement and prediction method providing a user an ability to produce a business intelligence (BI) performance dimension (PD) in a geo-spatial database, the method comprising:
(a) providing the geo-spatial database comprising a plurality of data records, wherein each data record is categorized by a unique combination of one or more dimensions, wherein each dimension comprises one or more data attributes;
(b) specifying a set of criteria on which to base a new PD via a display interface (“PD wizard”) operatively coupled to the geo-spatial database;
(c) extracting a set of data adhering to the set of criteria, wherein the new PD comprises the set of data,
(d) storing the new PD to one or more data records comprising data that adheres to the set of criteria; and
(e) exposing performance results by creating a new drill path for the new PD by creating a hierarchical order of the selected dimensions by listing (without programming).

18. The method of claim 17, wherein the set of criteria comprises a plurality of data attributes.

19. The method of claim 17, wherein the one or more pre-defined business rules are grouped by time comparisons, statistics, or rolling periods.

20. The method of claim 17, wherein the user provides a name for the label characterizing the new PD.
